(19) United States
(12) Patent Application Publication
(10) Pub. No.: US 2023/0330760 A1
(43) Pub. Date: Oct. 19, 2023

(54) WORK MACHINE

(71) Applicant: Koki Holdings Co., Ltd., Tokyo (JP)

(72) Inventor: Naoto ICHIHASHI, Ibaraki (JP)

(73) Assignee: Koki Holdings Co., Ltd., Tokyo (JP)

(21) Appl. No.: 18/020,257

(22) PCT Filed: Aug. 6, 2021
(86) PCT No.: PCT/JP2021/029292

§ 371 Date: Feb. 7, 2023

(30) Foreign Application Priority Data
Aug. 31, 2020 (JP) 2020-145367
Aug. 31, 2020 (JP) 2020-145368

(51) Int. Cl. B23D 59/00; B27G 19/04

(52) U.S. Cl. CPC B23D 59/006; B27G 19/04

(57) ABSTRACT

A dust collection box includes: a box entrance section through which an air flow is let into a dust chamber; and a box-side exhaust outlet through which the air flow in the dust chamber is let out of the dust chamber. The box-side exhaust outlet is disposed behind the box entrance section. The dust collection box also has a case guide section which guides the air flow introduced into the dust chamber toward the downstream side. Accordingly, the air flow introduced into the dust chamber is caused to flow downward at a front end of the dust chamber, to flow backward at a lower end of the dust chamber, and to flow upward at a rear end of the dust chamber.

### TECHNICAL FIELD

The present invention relates to a work machine.

### BACKGROUND ART

The following Patent Literature 1 discloses a portable circular saw (work machine) including a dust box (dust collection box). The dust box is configured to be disposed on a lateral side of a saw cover covering a circular saw blade and store chips generated during operation of the portable circular saw inside the dust box.

### CITATION LIST

### Patent Literature

[Patent Literature 1]
Japanese Patent Laid-Open No. 2011-68073

### SUMMARY OF INVENTION

### Technical Problem

Here, when a machining material to be machined using a portable circular saw is a metal such as a mild steel, chips generated during cutting have a relatively high temperature. For this reason, when chips come into contact with a portion of the portable circular saw, there is concern that a contact location may be affected due to heat of the chips. For example, there is a likelihood that a saw cover or a dust collection box will be thermally deformed due to chips. Accordingly, it is desired that work machines have a structure capable of increasing heat resistance.

In consideration of the foregoing circumstances, an object of the present invention is to provide a work machine capable of improving heat resistance.

### Solution to Problem

A work machine according to one or more embodiments of the present invention includes a motor that drives a tip tool for performing cutting forward with respect to a machining material, a tool cover that covers at least a portion of the tip tool, and a dust collection box that is connected to the tool cover. The dust collection box includes an intake part for causing an air flow generated due to driving of the motor or cutting to flow into the dust collection box, and an exhaust part for causing the air flow which has flowed into the dust chamber to be discharged to the outside of the dust chamber. The intake part and the exhaust part are apart from each other in a forward-rearward direction, and an air passage connecting the intake part and the exhaust part is formed in the dust collection box in a manner of extending in the forward-rearward direction.

In the work machine according to one or more embodiments of the present invention, the intake part is provided in a front part of the dust collection box, and the exhaust part is provided in a rear part of the dust collection box. In the work machine according to one or more embodiments of the present invention, the exhaust part and the intake part are disposed at the same positions in an upward-downward direction.

The work machine according to one or more embodiments of the present invention further includes a fan that rotates due to driving of the motor and generates the air flow. The tool cover has a ventilation part connected to the intake part, and the air flow generated by the fan is sent to the intake part by the ventilation part.

A work machine according to one or more embodiments of the present invention includes a motor that drives a tip tool for performing cutting forward with respect to a machining material, a fan that rotates due to driving of the motor and generates an air flow, a tool cover that covers at least a portion of the tip tool, and a dust collection box that is connected to the tool cover. The tool cover is provided with a ventilation part for sending the air flow generated by the fan to the dust collection box. The dust collection box has a resin case internally having a dust chamber for collecting machining chips generated during cutting, an intake part connected to the ventilation part and causing the air flow to flow into the dust chamber, and an exhaust part causing the air flow which has flowed into the dust chamber to be discharged to an inward side of the tool cover. The work machine further includes an air passage that is configured to cause the air flow generated by the fan to flow into the dust collection box via the intake part and to be discharged to the inward side of the tool cover from the exhaust part.

In the work machine, the ventilation part has a first ventilation exit part for causing the air flow not including the machining chips to flow out to the intake part, and a second ventilation exit part for causing the air flow including the machining chips to flow out to the intake part.

In the work machine according to claim 5 which is one or more embodiments of the present invention, the first ventilation exit part and the second ventilation exit part are disposed adjacent to each other. In the work machine according to one or more embodiments of the present invention, the first ventilation exit part and the second ventilation exit part are open in the same direction. In the work machine according to one or more embodiments of the present invention, the first ventilation exit part is disposed on a side above the second ventilation exit part. The air flow which has flowed out to the intake part from the first ventilation exit part is guided to a lower side by the guide part.

In the work machine according to one or more embodiments of the present invention, the second ventilation exit part communicates with the inside of the tool cover. The ventilation part is configured to include a duct for causing the air flow to branch. The duct has a first duct exhaust part for causing one of the branched air flows to be discharged to the first ventilation exit part and a second duct exhaust part for causing the other of the branched air flows to be discharged to the inside of the tool cover, and the other of the branched air flows is discharged to the second ventilation exit part side by the second duct exhaust part. In the work machine according to one or more embodiments of the present invention, the tip tool is a circular saw blade having a circular shape. The second duct exhaust part is disposed on the inward side of an external shape of the circular saw blade in a radial direction when viewed in a plate thickness direction of the circular saw blade.

In the work machine according to one or more embodiments of the present invention, a first straightening part is provided between the second ventilation exit part and the second duct exhaust part. The first straightening part straightens the air flow discharged from the second duct exhaust part to the second ventilation exit part side.

In the work machine according to one or more embodiments of the present invention, the second ventilation exit part has a second straightening part. The second straightening part straightens the air flow flowing into the second ventilation exit part to the dust collection box side.

In the work machine according to one or more embodiments of the present invention, the guide part constitutes a portion of an inner circumferential surface of the dust chamber.

In the work machine according to one or more embodiments of the present invention, the tip tool is a circular saw blade having a circular shape, and the tool cover is configured to cover an upper part of the circular saw blade. A measurement of the dust chamber in an upward-downward direction is set to be smaller than a measurement thereof in a forward-rearward direction.

A work machine according to one or more embodiments of the present invention includes a motor that drives a tip tool for performing cutting with respect to a machining material, a fan that rotates due to driving of the motor and generates an air flow, a tool cover that covers at least a portion of the tip tool, and a dust collection box that is disposed adjacent to the tool cover. The dust collection box is configured to include a resin case internally having a dust chamber for collecting machining chips generated during cutting, an intake part for causing the air flow to flow into the dust chamber, an exhaust part apart from the intake part in a forward-rearward direction and causing the air flow which has flowed into the dust chamber to be discharged to the outside of the dust chamber, and a guide part for guiding the air flow flowing into the dust chamber from the intake part to a lower side.

In the work machine according to one or more embodiments of the present invention, the tip tool is a circular saw blade having a circular shape. The intake part is positioned in front of a rotation center of the circular saw blade. The exhaust part is positioned behind the rotation center of the circular saw blade.

In the work machine according to one or more embodiments of the present invention, the intake part is positioned behind a front end of the circular saw blade. The exhaust part is positioned in front of a rear end of the circular saw blade. In the work machine according to one or more embodiments of the present invention, a base for sliding on the machining material is provided below the tool cover. The dust collection box is attached to one side of the tool cover in a lateral direction.

A work machine according to one or more embodiments of the present invention includes a motor that drives a tip tool for performing cutting forward with respect to a machining material, a tool cover that covers at least a portion of the tip tool, and a dust collection box that is connected to one side of the tool cover in a lateral direction. The dust collection box has a case internally having a dust chamber for collecting machining chips generated during cutting, an intake part connected to the ventilation part and causing an air flow to flow into the dust chamber, and an exhaust part causing the air flow which has flowed into the dust chamber to be discharged to an inward side of the tool cover. The work machine further includes an air passage that is configured to cause the air flow to flow into the dust collection box via the intake part and to be discharged to the inward side of the tool cover from the exhaust part. In the work machine according to one or more embodiments of the present invention, the air flow is configured to cool an inner wall of the dust chamber so as to be straightened by the inner wall and to be directed to the exhaust part. A work machine according to one or more embodiments of the present invention includes a motor that drives a tip tool for performing cutting with respect to a machining material; a tool cover that has a tool accommodation region for accommodating at least a portion of the tip tool; a dust collection box that has a dust chamber connected to the tool cover and collecting machining chips generated during cutting, an intake part for causing air to flow into the dust chamber, and an exhaust part for causing air which has flowed into the dust chamber to be discharged to the outside of the dust chamber; and a blocking part that is provided in the tool accommodation region and divides the tool accommodation region into an operation region and a non-operation region. A portion of the tip tool is accommodated in the operation region, and the exhaust part communicates with the non-operation region.

### Advantageous Effects of Invention

According to one or more embodiments of the present invention, it is possible to improve heat resistance.

### BRIEF DESCRIPTION OF DRAWINGS

FIG. 1 is a side view illustrating a cutting tool according to the present embodiment viewed from the right side.

FIG. 2 is a side view of the cutting tool illustrated in FIG. 1 viewed from the left side.

FIG. 3 is a perspective view of the cutting tool illustrated in FIG. 1 viewed obliquely from the right in the front.

FIG. 4 is a perspective view illustrating a state in which a dust collection box of the cutting tool illustrated in FIG. 3 is detached from a tool main body and viewed obliquely from the right in the front.

FIG. 5 is a cross-sectional view illustrating the inside of the cutting tool illustrated in FIG. 2 viewed from the upper side (a cross-sectional view along line 5-5 in FIG. 2).

(A) of FIG. 6 is a side view of a duct illustrated in FIG. 5 viewed from the right side, (B) of FIG. 6 is a front view of the duct in (A) of FIG. 6 viewed from the front side, and (C) of FIG. 6 is a side view of the duct in (A) of FIG. 6 viewed from the left side.

FIG. 7 is a perspective view illustrating a positional relationship between a saw cover of the cutting tool illustrated in FIG. 4 and a circular saw blade and viewed obliquely from the left in the front.

FIG. 8 is a cross-sectional view illustrating the inside of a tool cover illustrated in FIG. viewed from the left side (a cross-sectional view along line 8-8 in FIG. 5).

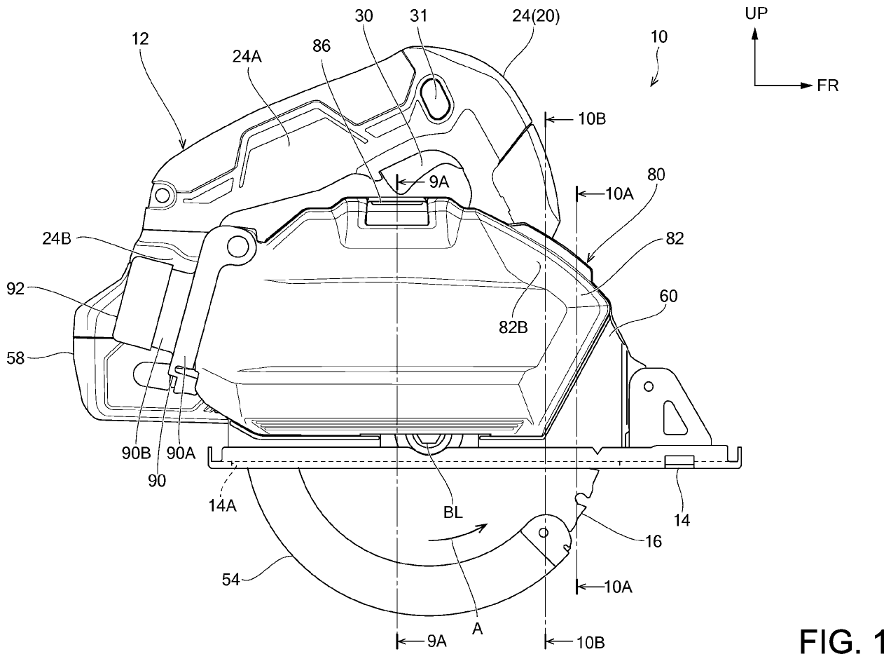

(A) of FIG. 9 is a cross-sectional view of a part of an attachment/detachment button of the dust collection box illustrated in FIG. 1 viewed from the front side (a cross-sectional view along line 9A-9A in FIG. 1), and (B) of FIG. 9 is a cross-sectional view of the inside of a lower side ventilation exit part of the saw cover illustrated in FIG. 12 viewed obliquely from above in the front (a cross-sectional view along line 9B-9B in FIG. 12).

(A) of FIG. 10 is a cross-sectional view of a front end part of the dust collection box illustrated in FIG. 1 viewed from the front side (a cross-sectional view along line 10A-10A in FIG. 1), and (B) of FIG. 10 is a cross-sectional view of a front end side portion of the dust collection box illustrated in FIG. 1 viewed from the front side (a cross-sectional view along line 10B-10B in FIG. 1).

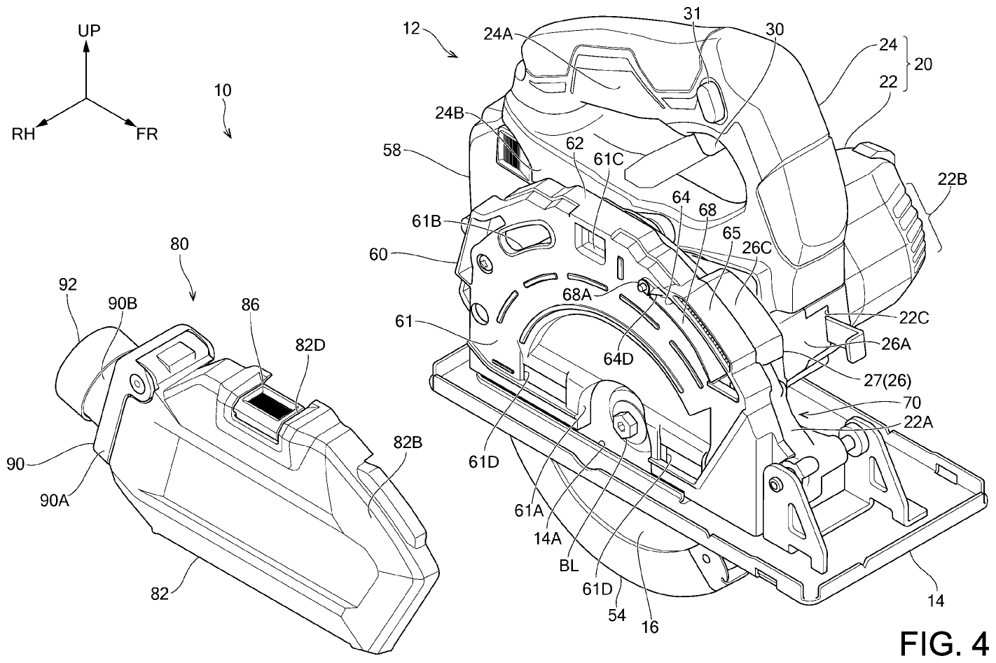

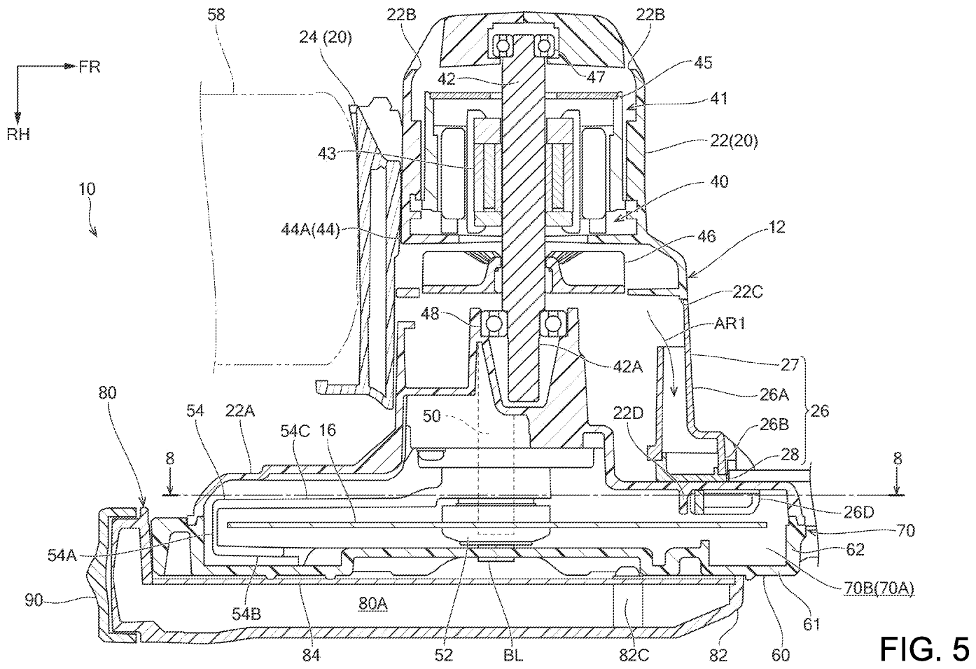

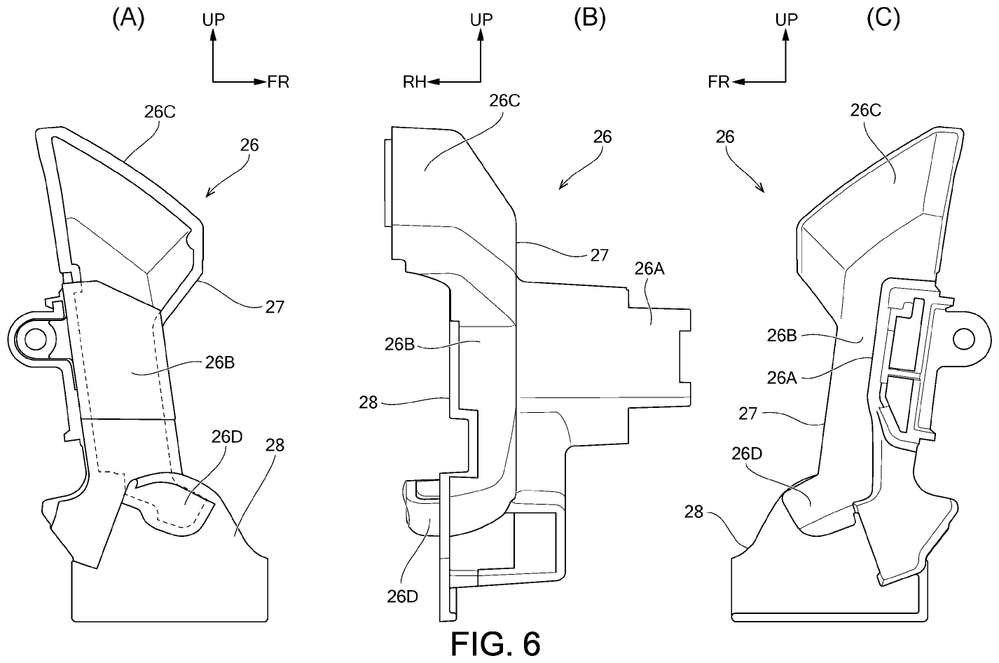

FIG. 11 is an exploded perspective view of the dust collection box illustrated in FIG. 4 viewed obliquely from the left in the rear.

FIG. 12 is a side view illustrating a positional relationship between an inner case of the dust collection box illustrated in FIG. 11 and the saw cover and viewed from the right side.

### DESCRIPTION OF EMBODIMENT

Hereinafter, using the drawings, a cutting tool 10 serving as a work machine according to the present embodiment will be described. An arrow UP, an arrow FR, and an arrow RH suitably indicated in the drawings respectively indicate the upper side, the front side, and the right side of the cutting tool 10. Further, when directions to the upper and lower sides, the front and rear sides, and the left and right sides are used in the following description, they respectively indicate an upward-downward direction, a forward-rearward direction, and a lateral direction of the cutting tool 10 unless otherwise particularly stated.

The cutting tool 10 is configured to serve as a tool for cutting a machining material. As illustrated in FIGS. 1 to 4, the cutting tool 10 is configured to include a tool main body 12 for performing cutting of a machining material, and a dust collection box 80 for storing chips which are machining chips generated during machining. Hereinafter, first, a constitution of the tool main body 12 will be described. Next, a constitution of the dust collection box 80 will be described.

(Regarding Tool Main Body 12)

The tool main body 12 configured to include a base 14, a housing 20, a drive mechanism 40 and a control part 56 accommodated inside the housing 20, a battery pack 58, a saw cover 60, and a guard member 68.

(Regarding Base 14)

The base 14 is formed to have a substantially rectangular plate shape having the upward-downward direction as a plate thickness direction and having the forward-rearward direction as a longitudinal direction. Further, during machining by the cutting tool 10, the base 14 is placed on the upper side of a machining material and the cutting tool 10 is moved to the front side so that a lower surface of the base 14 slides on an upper surface of the machining material.

A tool insertion part 14A for disposing a circular saw blade 16 serving as a tip tool is formed in a penetrating manner in a left side part of the base 14, and the tool insertion part 14A is formed to have a substantially rectangular hole shape having the forward-rearward direction as the longitudinal direction in a plan view. Here, the circular saw blade 16 is formed to have a substantially circular plate shape having the lateral direction as the plate thickness direction, and a central part of the circular saw blade 16 is fixed to an output shaft 50 of the drive mechanism 40 (which will be described below) in an integrally rotatable manner. Further, the circular saw blade 16 is disposed inside the tool insertion part 14A, an upper part of the circular saw blade 16 protrudes from the base 14 to the upper side, and a lower end side portion of the circular saw blade 16 protrudes from the base 14 to the lower side. In addition, during operation of the cutting tool 10, the circular saw blade 16 is configured to rotate to one side in a rotation direction (the side in the arrow A direction in FIG. 1, and this direction will hereinafter be referred to as a cutting rotation direction) around the output shaft 50.

(Regarding Housing 20)

As illustrated in FIGS. 1 to 5, the housing 20 constitutes the contour of the tool main body 12 and is disposed on the upper side of the base 14. The housing 20 is configured to include a main body housing 22 accommodating the drive mechanism 40 (which will be described below), a handle housing 24 constituting the upper part of the housing 20, and a duct 26.

The main body housing 22 is formed to have a substantially bottomed cylindrical shape opening to the right side. A cover base part 22A projecting to the outward side in a radial direction is formed in the right end part of the main body housing 22. The cover base part 22A is formed to have a substantially semicircular shape sticking out to the upper side when viewed from the right side, and an outer circumferential part of the cover base part 22A is bent to the left side (refer to FIG. 5). Further, a front end part and a rear end part of the cover base part 22A are coupled to the base 14. The cover base part 22A is made of a metal having higher heat resistance and wear resistance than a resin material.

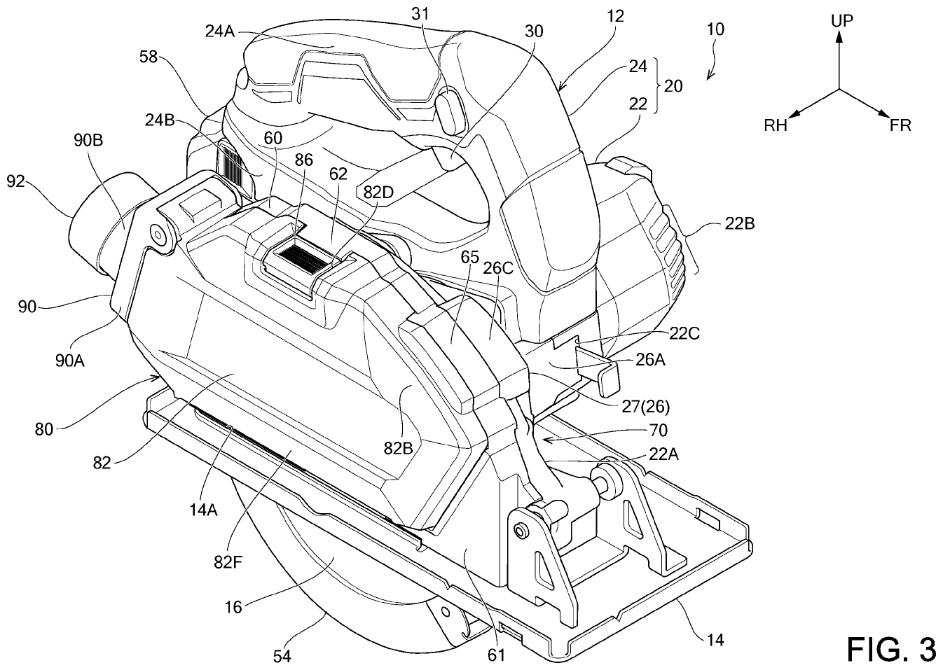

In the left end part of the main body housing 22, a plurality of intake ports 22B is formed in a penetrating manner at corner parts on the front side and the rear side. The plurality of intake ports 22B is formed throughout the main body housing 22 from a bottom wall (left end part) to front and rear side walls and is disposed side by side with a predetermined gap therebetween in the upward-downward direction. In the front wall in the right end part of the main body housing 22, an opening part 22C opening to the front side (refer to FIGS. 3 to 5) is formed in a penetrating manner in a portion excluding the cover base part 22A, and the opening part 22C is formed to have a substantially rectangular shape when viewed from the front side.

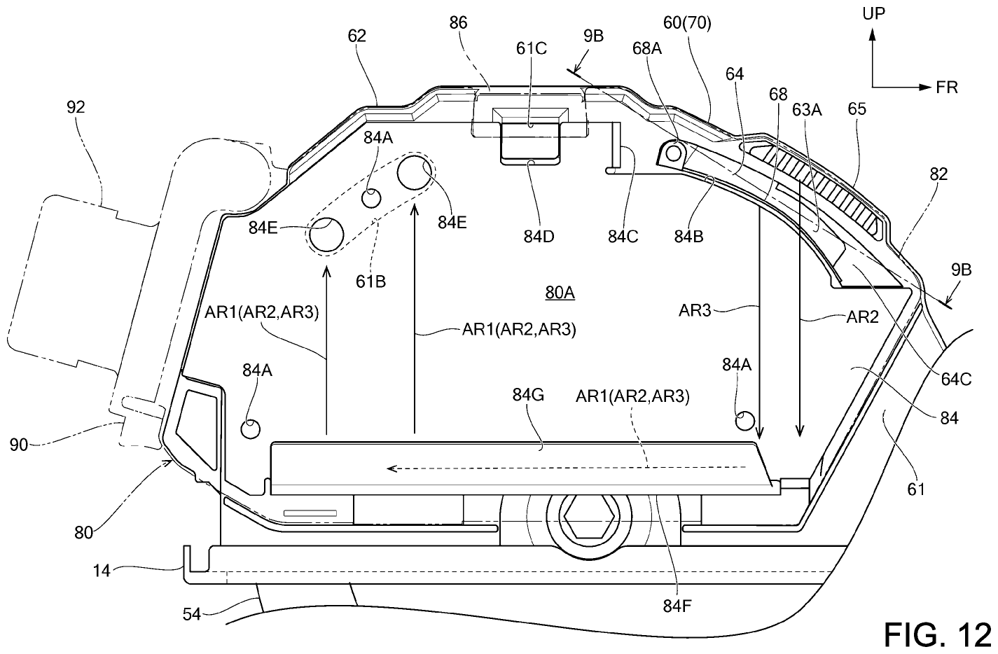

In addition, on the right side surface of the cover base part 22A, a lower side straightening piece 22D (refer to FIGS. 5 and 8) serving as a first straightening part is formed in a front end side portion. The lower side straightening piece 22D extends in the upward-downward direction while having the forward-rearward direction as the plate thickness direction and is disposed between the circular saw blade 16 and the cover base part 22A.

The handle housing 24 is formed to have a substantially hollow D-shape when viewed from the left side, is disposed such that the main body housing 22 is covered from the upper side and the rear side, and is coupled to the main body housing 22. An upper end part of the handle housing 24 is configured to serve as a handle part 24A which is gripped by a worker, and the handle part 24A is inclined to the lower side toward the rear side in a side view.

A trigger 30 is provided in a front end side portion of the handle part 24A. The trigger 30 is configured to protrude from the handle part 24A to the lower side and be able to be subjected to a pulling operation to the upper side. In addition, in the handle part 24A, a lock button 31 for locking a pulling operation of the trigger 30 is provided on the upper side of the trigger 30. Moreover, a switch mechanism (not illustrated) is provided inside the handle part 24A. The switch mechanism has a switch (not illustrated) operated by the trigger 30. The switch is configured to be electrically connected to the control part 56 (which will be described below) and output an output signal corresponding to the operation state of the trigger 30 to the control part 56.

In addition, a rear side lower end part of the handle housing 24 is configured to serve as a battery mounting part 24B for mounting the battery pack 58 (which will be described below). A connector (not illustrated) is provided in the battery mounting part 24B, and the connector is electrically connected to the control part 56 (which will be described below).

(Regarding Duct 26)

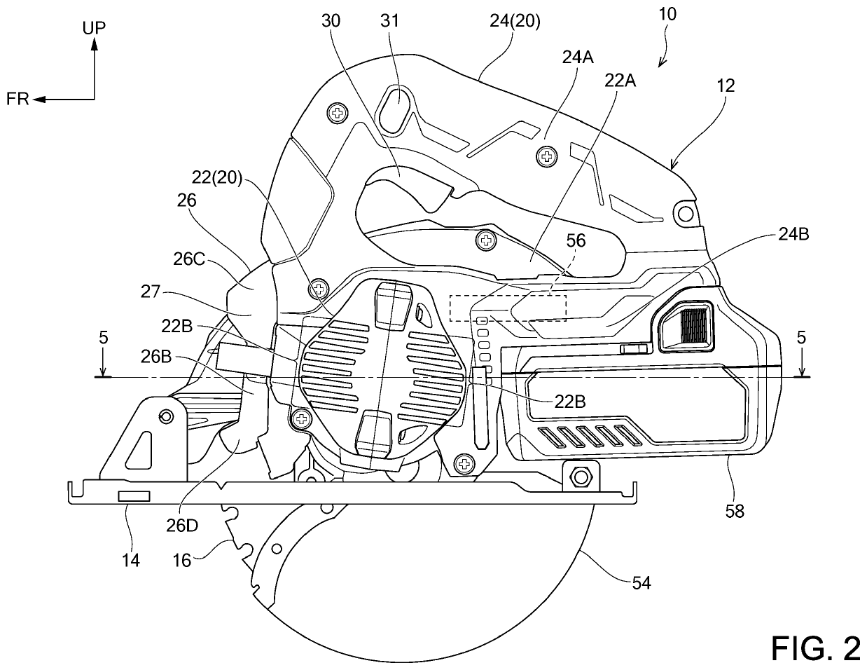

As illustrated in FIGS. 2 to 6, the duct 26 is disposed adjacent to the left side of the cover base part 22A, is attached to the cover base part 22A, and is configured to serve as a ventilation duct for sending an air flow AR1 generated by a fan 46 (which will be described below) to the dust collection box 80. The duct 26 is constituted of two members such as a duct main body 27 and a duct cover 28, and the duct 26 is constituted by assembling the duct cover 28 in the duct main body 27. The duct cover 28 is a component to be attached such that the left side of the circular saw blade 16 is covered. However, since it is formed of a transparent material, a worker can see the front end (cutting location) of the circular saw blade 16 from the left side through a portion of the duct cover 28.

The duct 26 has an inflow duct part 26A constituting the left part of the duct 26, and an outflow duct part 26B constituting a right part of the duct 26. The inflow duct part 26A is formed to have a substantially rectangular tube shape having the lateral direction as an axial direction. The inflow duct part 26A is disposed inside the main body housing 22 in the opening part 22C of the main body housing 22, and the front wall of the inflow duct part 26A blocks the opening part 22C (refer to FIG. 5). In addition, the front wall and upper and lower walls of the left end part of the inflow duct part 26A are cut out, and the inside of the inflow duct part 26A and the inside of the main body housing 22 communicate with each other.

The outflow duct part 26B is formed to have a substantially rectangular tube shape having the upward-downward direction as the axial direction, and the right end part of the inflow duct part 26A is connected to an intermediate part of the outflow duct part 26B in the upward-downward direction. A first duct exhaust part 26C is formed in the upper end part of the outflow duct part 26B. The first duct exhaust part 26C is formed to have a substantially U-shape opening to the right side when viewed in the longitudinal direction of the outflow duct part 26B and is bent to the right side along the outer circumferential part of the cover base part 22A. Accordingly, a portion of the air flow AR1 which has flowed into the inflow duct part 26A is blown out to the right side from the first duct exhaust part 26C (refer to (A) of FIG. 10 and (B) of FIG. 10).

In addition, as also illustrated in (A) of FIG. 10, a second duct exhaust part 26D protruding to the front side and having a tubular shape is formed in a lower end part of the outflow duct part 26B. The second duct exhaust part 26D is bent to the right side and is disposed in a manner of straddling the lower side of the front end part of the cover base part 22A. Further, a tip part of the second duct exhaust part 26D is disposed between the front end part of the cover base part 22A and the front end part of the circular saw blade 16. That is, in a side view, the second duct exhaust part 26D is disposed on the inward side of the external shape of the circular saw blade 16 in the radial direction and is disposed at a position overlapping the front end part of the circular saw blade 16 (refer to FIG. 8). In addition, the tip part of the second duct exhaust part 26D is disposed near the front side of the lower side straightening piece 22D of the cover base part 22A, and a tip opening part of the second duct exhaust part 26D opens to the upper side (refer to FIG. 8). For this reason, a portion of the air flow AR1 which has flowed into the inflow duct part 26A is configured to be blown out to the upper side from the second duct exhaust part 26D and be straightened by the lower side straightening piece 22D.

That is, the duct 26 is configured to serve as a ventilation duct for causing the air flow AR1 which has flowed into the inflow duct part 26A to branch into an air flow AR2 to be discharged from the first duct exhaust part 26C and an air flow AR3 to be discharged from the second duct exhaust part 26D. Further, the direction of the air flow AR3 blown out from the second duct exhaust part 26D is set to substantially coincide with the cutting rotation direction of the circular saw blade 16.

(Regarding Drive Mechanism 40)

As illustrated in FIG. 5, the drive mechanism 40 is configured to include a motor 41 and the output shaft 50. The motor 41 is accommodated inside the main body housing 22. The motor 41 is configured to include a rotation shaft 42, a rotor 43, and a stator 44.

The rotation shaft 42 is disposed while having the lateral direction as the axial direction. Further, the left end part of the rotation shaft 42 is rotatably supported by a first motor bearing 47 fixed to the main body housing 22, and the right side portion of the rotation shaft 42 is rotatably supported by a second motor bearing 48 fixed to the main body housing 22. Further, the right end part of the rotation shaft 42 protrudes from the second motor bearing 48 to the right side, and a pinion gear 42A is formed in the right end part of the rotation shaft 42.

The rotor 43 is configured to be formed to have a substantially cylindrical shape having the lateral direction as the axial direction, be disposed on the outward side of the rotation shaft 42 in the radial direction, and be integrally rotatable with the rotation shaft 42. The stator 44 is formed to have a substantially cylindrical shape having the forward-rearward direction as the axial direction and is supported by the main body housing 22 on the outward side of the rotor 43 in the radial direction. The stator 44 has a stator holder 44A, and a stator coil (not illustrated) is wound around the stator holder 44A. A motor substrate 45 is fixed to the left end part of the stator holder 44A, and the stator coil is connected to the motor substrate 45. In addition, the motor substrate 45 is electrically connected to the control part 56 (which will be described below) through a lead line (not illustrated).

In the right side portion of the rotation shaft 42, the fan 46 is provided in an integrally rotatable manner on the left side of the second motor bearing 48. The fan 46 is configured to serve as a centrifugal fan. Specifically, the fan 46 is configured to causes air to flow into the main body housing 22 from the intake ports 22B of the main body housing 22 and generate the air flow AR1 flowing into the duct 26 from the opening part 22C of the main body housing 22.

The output shaft 50 is disposed inside the main body housing 22 while having the lateral direction as the axial direction. Specifically, the output shaft 50 is disposed on the side below the right side end part of the rotation shaft 42 of the motor 41 (one end part in the axial direction) and on the slightly rear side with respect to the rotation shaft 42 and is rotatably supported by the main body housing 22. An output gear (not illustrated) is provided in an integrally rotatable manner in the left end part of the output shaft 50.

Moreover, a transmission gear (deceleration mechanism, not illustrated) is provided between the rotation shaft 42 and the output shaft 50. The transmission gear is configured to serve as a two-speed gear and is meshed with the pinion gear 42A of the rotation shaft 42 and the output gear of the output shaft 50. In addition, the right end part of the output shaft 50 is configured to serve as a tool attachment part, and the tool attachment part is disposed inside the cover base part 22A. In addition, the tool attachment part is formed to have a substantially cylindrical shape opening to the right side, and a male screw is formed in an inner circumferential part of the tool attachment part. Further, the central part of the circular saw blade 16 is extrapolated in the tool attachment part with a washer 52 therebetween, and the circular saw blade 16 is fixed to the right end part of the output shaft 50 by means of a bolt BL. Accordingly, during driving of the motor 41, the output shaft 50 and the circular saw blade 16 rotate in the cutting rotation direction around the output shaft 50.

As illustrated in FIGS. 1 to 5 and 8, a lower part of the circular saw blade 16 is covered by a protective cover 54. The protective cover 54 is formed to have a substantially semicircular shape sticking out to the lower side when viewed from the right side and is formed to have a recessed shape opening to the upper side. Specifically, the protective cover 54 is configured to include an outer circumferential protective part 54A covering the circular saw blade 16 from the outward side in the radial direction, a first side protective part 54B extending from the right end part of the outer circumferential protective part 54A to the inward side of the circular saw blade 16 in the radial direction, and a second side protective part 54C extending from the left end part of the outer circumferential protective part 54A to the inward side of the circular saw blade 16 in the radial direction (refer to FIG. 5). Further, the second side protective part 54C is coupled to the output shaft 50 such that it can rotate around the output shaft 50.

Moreover, the protective cover 54 is biased around the output shaft 50 by a biasing spring (not illustrated) and is held at a protection position illustrated in FIGS. 1 to 5. Meanwhile, during cutting by the cutting tool 10, the protective cover 54 is pressurized to the rear side by a machining material and rotates to the other side around the output shaft 50 against a biasing force of the biasing spring (position indicated by the two-point dashed line in FIG. 8, and this position of the protective cover 54 will hereinafter be referred to as an operation position). Further, at the operation position of the protective cover 54, the lower part of the circular saw blade 16 is exposed, and the upper part of the circular saw blade 16 is configured to be covered by the protective cover 54.

(Regarding Control Part 56)

As illustrated in FIG. 2, the control part 56 is accommodated inside the front end part of the battery mounting part 24B in the handle housing 24. The switch mechanism of the trigger 30 and the motor 41 are electrically connected to the control part 56. Accordingly, the motor 41 is driven in response to a pulling operation of the trigger 30, and the circular saw blade 16 rotates around the output shaft 50.

(Regarding Battery Pack 58)

The battery pack 58 is formed to be a rectangular parallelepiped. Further, the battery pack 58 is mounted in the battery mounting part 24B of the cutting tool 10 from the rear side. Moreover, the battery pack 58 has a connector (not illustrated). In a state in which the battery pack 58 is mounted, the connector is configured to be connected to the connector of the handle housing 24 so that power is supplied from the battery pack 58 to the control part 56.

(Regarding Saw Cover 60)

As illustrated in FIGS. 3 to 5 and 7 to 10, the saw cover 60 is configured to be made of a resin, be disposed adjacent to the right side of the cover base part 22A of the main body housing 22, and serve as a cover part covering the circular saw blade 16 from the upper side and the right side. Specifically, the saw cover 60 is configured to include a side cover part 61 having a substantially semicircular plate shape having the lateral direction as the plate thickness direction, and a circumferential cover part 62 extending from an outer circumferential end part of the side cover part 61 to the right side. Further, the side cover part 61 is configured to serve as a wall part covering the upper part of the circular saw blade 16 from the right side (one side of the motor 41 in the axial direction), and the circumferential cover part 62 is configured to serve as a wall part covering the upper part of the circular saw blade 16 from the outward side in the radial direction. The side cover part 61 is formed of a permeable resin (plastic).

In addition, the circumferential cover part 62 is disposed adjacent to the right side of the outer circumferential part of the cover base part 22A and is fastened and fixed to the cover base part 22A. Further, a tool cover 70 is constituted of the cover base part 22A, the duct 26, and the saw cover 60, and the upper part of the circular saw blade 16 is covered by the tool cover 70. In addition, the inside of the tool cover 70 is configured to serve as a tool accommodation region 70A accommodating the upper part of the circular saw blade 16.

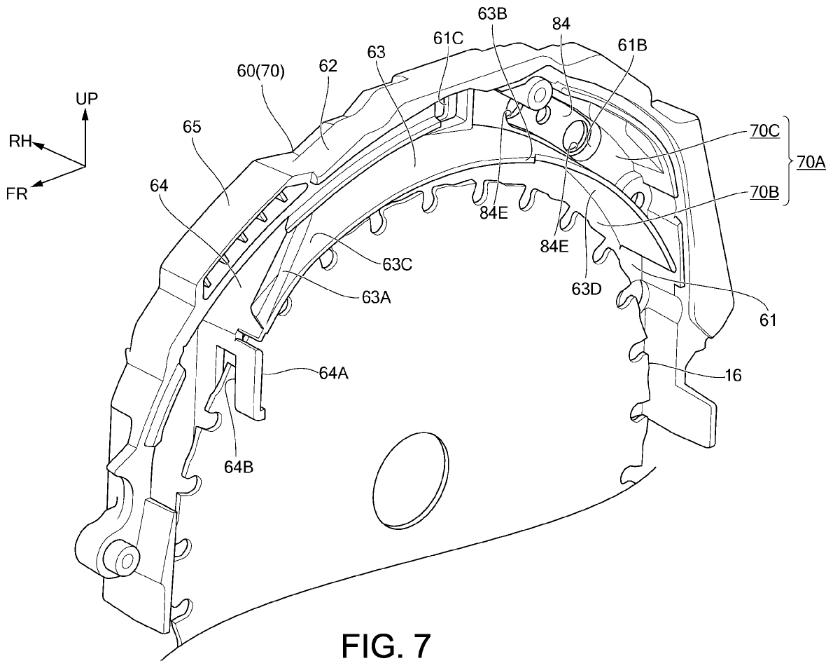

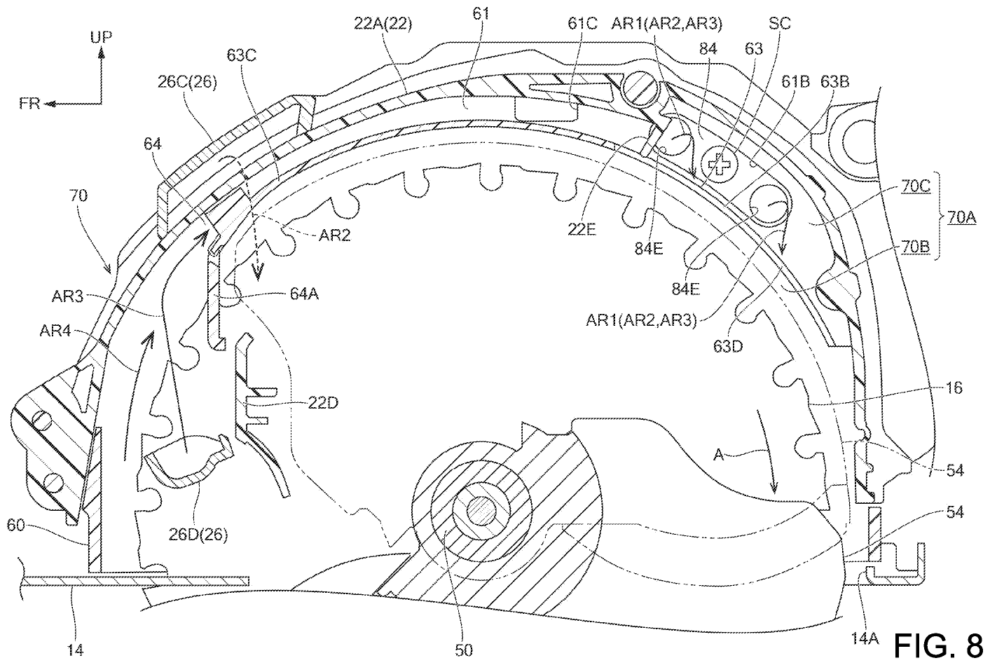

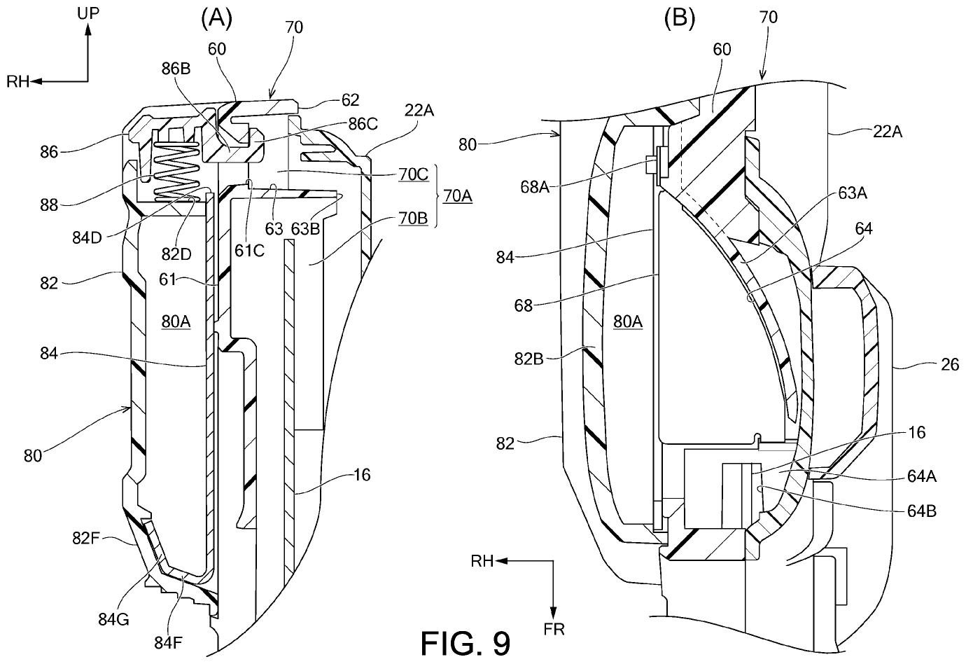

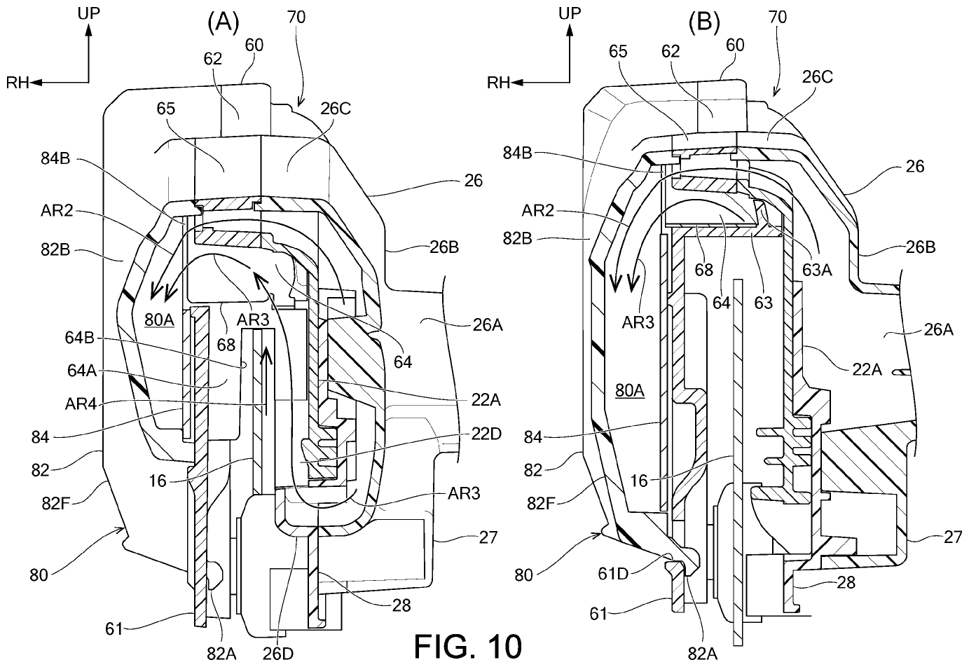

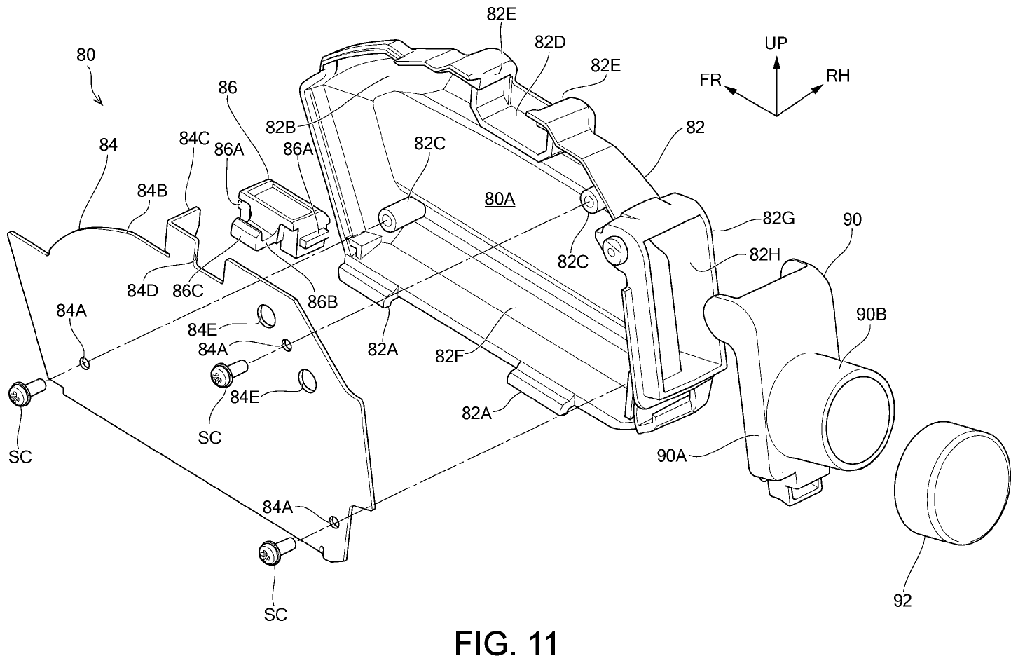

As illustrated in FIGS. 7 and 8, in the upper part of the side cover part 61, a blocking part 63 is formed on the outward side of the circular saw blade 16 in the radial direction. The blocking part 63 is formed to have a substantially elongated plate shape having the radial direction of the circular saw blade 16 as the plate thickness direction and extending in a circumferential direction of the circular saw blade 16 and is formed to protrude from an inner surface of the side cover part 61 to the left side. That is, the blocking part 63 is a plate member having a curved shape extending in the circumferential direction of the circular saw blade 16 when viewed from the left side.

Accordingly, the tool accommodation region 70A is divided by the blocking part 63 in the radial direction of the circular saw blade 16. Specifically, the inward side portion of the circular saw blade 16 in the radial direction (inner portion of the blocking part 63) with respect to the blocking part 63 in the tool accommodation region 70A is configured to serve as an operation region 70B, and the outward side portion thereof in the radial direction (outer portion of the blocking part 63) with respect to the blocking part 63 in the tool accommodation region 70A is configured to serve as a non-operation region 70C. Further, at the operation position of the protective cover 54, the protective cover 54 is configured to be disposed in the operation region 70B. In addition, a left end part 63B (tip part) of the blocking part 63 is disposed on the left side of the circumferential cover part 62 and the circular saw blade 16 and is disposed near the right side of the cover base part 22A. That is, a gap in the lateral direction is formed between the left end part 63B (tip part) of the blocking part 63 and the right side of the cover base part 22A. In addition, a gap in the forward-rearward direction is formed between the rear end of the blocking part 63 and the rear end inner wall of the cover base part 22A.

As also illustrated in (B) of FIG. 9, a ventilation guide part 63A serving as a second straightening part is formed on the upper surface of a front part 63C of the blocking part 63. The ventilation guide part 63A is inclined to the right side in a curved shape from the front left end part of the blocking part 63 toward the rear end side of the blocking part 63 (a side of the circular saw blade 16 in the cutting rotation direction). Moreover, the right part of the ventilation guide part 63A is disposed between the blocking part 63 and the circumferential cover part 62 and couples both to each other. Accordingly, a lower side ventilation exit part 64 constituted of the blocking part 63, the ventilation guide part 63A, and the circumferential cover part 62 and serving as a second ventilation exit part is formed in the saw cover 60, and the front end part of the lower side ventilation exit part 64 communicates with the operation region 70B of the tool accommodation region 70A.

In addition, in the front part 63C of the blocking part 63 constituting the lower side ventilation exit part 64, an upper side straightening piece 64A (refer to FIG. 7) serving as the first straightening part is formed at the front end thereof. The upper side straightening piece 64A extends from the front end part of the lower side ventilation exit part 64 (blocking part 63) to the lower side and is connected to the side cover part 61. In the lower end part of the upper side straightening piece 64A, a slit 64B opening to the lower side is formed in the intermediate part in the lateral direction. Further, the outer circumferential part on the front end side in the circular saw blade 16 is disposed inside the slit 64B. In addition, the lower end part of the left end part (the left side portion of the slit 64B) of the upper side straightening piece 64A is disposed near the front side of the upper end part in the lower side straightening piece 22D of the cover base part 22A (refer to FIG. 8). Inside the saw cover 60, a restriction part 22E is provided at a position in front of a box-side exhaust outlet 84E (which will be described below). The restriction part 22E is a wall-shaped portion protruding from the right side surface of the cover base part 22A to the right and restricts forward movement of an object positioned within the non-operation region 70C. In addition, the blocking part 63 has a shape inclined downward as the rear portion (rear part 63D) thereof goes to the rear. To be exact, the rear part 63D which is curved to be inclined toward the lower side is provided in the blocking part 63. The rear end of the rear part 63D is configured to be positioned behind the rear end of the circular saw blade 16. A gap in the forward-rearward direction is formed between the rear end of the rear part 63D (blocking part 63) and the rear end inner wall of the saw cover 60.

Moreover, the lower side ventilation exit part 64 opens to the right side. Namely, a hole part (exit hole 64C) for opening the lower side ventilation exit part 64 is formed in the side cover part 61, and the hole part is configured to serve as the exit hole 64C (refer to FIG. 12). Accordingly, inside the operation region 70B, the air flow AR3 discharged from the second duct exhaust part 26D and an air flow AR4 generated due to rotation of the circular saw blade 16 join together, and the joined air flow flows into the lower side ventilation exit part 64 and flows out to the right side from the exit hole 64C of the lower side ventilation exit part 64. In addition, at this time, inside the operation region 70B, chips which have been whirled up to the upper side by the circular saw blade 16 are inserted into the lower side ventilation exit part 64 and are discharged to the right side from the exit hole 64C of the lower side ventilation exit part 64. That is, the air flow AR4 is a chip-mixed air flow.

As illustrated in FIGS. 7 and 10, on the upper surface of the circumferential cover part 62, an upper side ventilation exit part 65 serving as a first ventilation exit part is formed on the side above the lower side ventilation exit part 64 and the left side of the first duct exhaust part 26C of the duct 26. Corresponding to the first duct exhaust part 26C, the upper side ventilation exit part 65 is formed to have a substantially U-shape opening to the lower side in a side view, and both end parts of the upper side ventilation exit part 65 in the longitudinal direction are connected to the circumferential cover part 62. Further, the first duct exhaust part 26C and the upper side ventilation exit part 65 are connected to each other, and the inside of the first duct exhaust part 26C and the inside of the upper side ventilation exit part 65 communicate with each other. Accordingly, the air flow AR2 discharged from the first duct exhaust part 26C is configured to be discharged to the right side from the upper side ventilation exit part 65.

Further, a ventilation part sending an air flow generated by the fan 46 to the dust collection box 80 (which will be described below) is constituted of the duct 26, and the lower side ventilation exit part 64 and the upper side ventilation exit part 65 of the saw cover 60.

As illustrated in FIG. 4, in the lower end part of the side cover part 61, a cover-side cutout part 61A is formed in the intermediate part in the forward-rearward direction, and the cover-side cutout part 61A is formed to have a substantially semicircular shape opening to the lower side in a side view. Further, in a state in which the dust collection box 80 is detached from the tool main body 12 (which will be described below), the bolt BL screwed to the output shaft 50 is exposed to the right side by the cover-side cutout part 61A.

A communication hole 61B is formed in a penetrating manner in the upper end part of the rear part of the side cover part 61. The communication hole 61B is formed to have a long hole shape in the longitudinal direction of the blocking part 63 in a side view and is disposed between the circumferential cover part 62 and the blocking part 63. That is, the inside and the outside of the non-operation region 70C of the tool cover 70 communicate with each other through the communication hole 61B.

In the upper end part of the side cover part 61, a button insertion part 61C into which a portion of an attachment/detachment button 86 of the dust collection box 80 (which will be described below) is inserted is formed in a penetrating manner between the lower side ventilation exit part 64 and the communication hole 61B, and the button insertion part 61C is formed to have a substantially rectangular shape. In addition, in the lower end part of the side cover part 61, a pair of front and rear fixing holes 61D for fixing the dust collection box 80 (which will be described below) is formed in a penetrating manner on the front side and the rear side of the cover-side cutout part 61A, and the fixing holes 61D are formed to have a substantially rectangular shape.

(Regarding Guard Member 68)

As illustrated in FIG. 4, (B) of FIG. 9, and FIG. 12, the guard member 68 is configured to be disposed inside the lower side ventilation exit part 64 of the saw cover 60 and serve as a member for protecting the bottom wall (blocking part 63) of the lower side ventilation exit part 64. The guard member 68 is formed to have a plate shape disposed parallel to the bottom wall of the lower side ventilation exit part 64. That is, in a side view, the guard member 68 is curved in a curved shape in the longitudinal direction of the blocking part 63. In addition, the guard member 68 is formed to have a substantially triangular shape such that a shape similar to the bottom surface of the lower side ventilation exit part 64 is formed when viewed in the plate thickness direction of the blocking part 63 and is disposed adjacent to the upper side on the bottom surface of the lower side ventilation exit part 64. That is, the right end part of the guard member 68 extends in the forward-rearward direction in a straight line shape, and the left end part of the guard member 68 is inclined to the right side in a curved shape toward the rear side.

In addition, the right end part of the guard member 68 slightly protrudes from the exit hole 64C of the lower side ventilation exit part 64 to the right side. Moreover, the rear end part of the guard member 68 is inserted into a groove part 64D formed in the lower side ventilation exit part 64 in the saw cover 60. In addition, a guard fixing part 68A protruding to the right side and bent to the upper side is formed in the rear end part of the guard member 68. Further, the guard fixing part 68A is disposed on the left side of the rear side circumferential edge part in the exit hole 64C of the lower side ventilation exit part 64 and is fixed to the side cover part 61 by welding.

(Regarding Dust Collection Box 80)

As illustrated in FIGS. 3 to 5 and 9 to 12, the dust collection box 80 is detachably attached to the saw cover 60 of the tool main body 12 and is disposed adjacent to the right side of the saw cover 60. Further, the dust collection box 80 is configured to store chips discharged from the lower side ventilation exit part 64 of the saw cover 60. The dust collection box 80 is configured to include an outer case 82 serving as a case, an inner case 84, the attachment/detachment button 86, and a dust collector connection part 90. The front end of the dust collection box 80 has a constitution in which a shape inclined downward to the rear is formed and the front end lower part of the side cover part 61 (the location marked with the reference sign 61 in FIG. 3) is not covered by the dust collection box 80 due to the inclined structure. Accordingly, it is constituted such that a worker can see the front end (cutting location) of the circular saw blade 16 through a portion (front end lower part) of the transparent side cover part 61 from the right side.

(Regarding Outer Case 82)

The outer case 82 is constituted using a transparent resin material and is formed to have a substantially rectangular box shape opening to the left side and having the forward-rearward direction as the longitudinal direction. Further, the inside of the outer case 82 is configured to serve as a dust chamber 80A for storing chips. A pair of front and rear box-side engagement hooks 82A is formed in an opening part of the outer case 82 on the lower side at positions corresponding to the fixing holes 61D of the saw cover 60. The box-side engagement hooks 82A extend in the forward-rearward direction, are formed to have a substantially reversed L-shape when viewed from the front side, and protrude from the outer case 82 to the lower side. Further, the box-side engagement hooks 82A are thrust into the fixing holes 61D of the saw cover 60 and are engaged with the lower side edge parts of the fixing holes 61D so that the lower end part of the outer case 82 is attached to the saw cover 60 (refer to (B) of FIG. 10). Meanwhile, the upper end part of the outer case 82 is attached to the saw cover 60 by the attachment/detachment button 86 (which will be described below).

Moreover, in a state in which the dust collection box 80 is attached to the saw cover 60, an upper wall of the outer case 82 is curved in a substantially arc shape in a side view such that the upper surface of the outer case 82 becomes flush with the upper surface of the saw cover 60. In addition, a portion facing the lower side ventilation exit part 64 and the upper side ventilation exit part 65 in the lateral direction in the right wall of the outer case 82 is configured to serve as a case guide section 82B (guide part). That is, the case guide section 82B constitutes a portion of an inner circumferential surface of the dust chamber 80A.

As illustrated in FIG. 11, a plurality of (three locations in the present embodiment) fixing bosses 82C for fixing the inner case 84 (which will be described below) is formed in the right wall of the outer case 82. The fixing bosses 82C are formed to have a substantially cylindrical shape having the lateral direction as the axial direction and protrude from the right wall of the outer case 82 to the left side. The fixing bosses 82C are respectively formed in the front end part, the rear end part, and the upper end part of the outer case 82, and FIG. 11 illustrates only the fixing bosses 82C at two locations provided in the front end part and the upper end part of the outer case 82.

In the upper wall of the outer case 82, a button accommodation part 82D for accommodating the attachment/detachment button 86 (which will be described below) is formed in the intermediate part in the forward-rearward direction. The button accommodation part 82D is formed to have a recessed shape opening to the upper side and the left side and is disposed on the right side of the button insertion part 61C of the saw cover 60. A pair of front and rear interlock ribs 82E is formed in the upper side opening part of the button accommodation part 82D. The interlock ribs 82E protrudes from the front and rear inner circumferential surfaces of the button accommodation part 82D to the inward side in the forward-rearward direction and extends in the lateral direction.

A case inclination part 82F is formed in the lower end part of the right wall of the outer case 82. The case inclination part 82F is inclined to the upper side toward the right side when viewed from the front side (refer to (A) of FIG. 9). An uneven shape is formed on the outer surface of the case inclination part 82F so that it is easy to hold and operate the dust collection box 80 (refer to (A) of FIG. 9).

A mounting part 82G for mounting the dust collector connection part 90 (which will be described below) is formed in the rear end part of the outer case 82. The mounting part 82G is formed to have a substantially rectangular tube shape having the forward-rearward direction as the axial direction and having the upward-downward direction as the longitudinal direction and protrudes from the outer case 82 to the rear side. In addition, the left part of the mounting part 82G protrudes to the left side beyond the outer case 82. Moreover, a discharge hole 82H allowing the inside of the outer case 82 and the inside of the mounting part 82G to communicate with each other is formed in a penetrating manner in the rear wall of the outer case 82.

(Regarding Inner Case 84)

As illustrated in FIGS. 11 and 12, the inner case 84 is constituted using a metal plate material. The inner case 84 is disposed while having the lateral direction as the plate thickness direction and is formed such that the external shape of the inner case 84 forms a shape similar to the external shape of the outer case 82 when viewed from the right side. That is, the upper end part of the inner case 84 is curved in a substantially arc shape sticking out to the upper side. Fixing holes 84A are formed in a penetrating manner in the inner case 84 at positions corresponding to the fixing bosses 82C of the outer case 82. Further, fixing screws SC are inserted into the fixing holes 84A from the left side and are screwed to the fixing bosses 82C so that the inner case 84 is fixed to the outer case 82. In addition, in a state in which the inner case 84 is fixed to the outer case 82, the inner case 84 is disposed on the inward side of the opening part of the outer case 82, and the dust chamber 80A is blocked by the inner case 84.

A box entrance section 84B serving as an intake part is formed outside the upper side of the front part of the inner case 84 in the dust collection box 80, and the box entrance section 84B is formed by being cut out such that it is lowered to the lower side from the outer circumferential part of the inner case 84 by one step when viewed from the right side. That is, a space (gap) extending forward, rearward, upward, and downward is formed between the front upper part of the inner case 84 and the front upper part of the outer case 82, and the space becomes the box entrance section 84B (intake part) opening in the leftward direction. Further, the lower side ventilation exit part 64 of the saw cover 60 is exposed (opens) to the dust chamber 80A such that it faces the box entrance section 84B. Due to the box entrance section 84B formed in this manner, an air passage allowing the upper side ventilation exit part 65 and the lower side ventilation exit part 64 of the saw cover 60 and the dust chamber 80A to communicate with each other and improving heat resistance of the dust collection box 80 is formed. In FIG. 11, a reference sign is applied to a position of the box entrance section 84B (cutout portion of the inner case 84) in a state in which the inner case 84 and the outer case 82 are assembled.

In the upper end part of the inner case 84, a stopper wall 84C is formed on the side above the rear end part of the box entrance section 84B. The stopper wall 84C is formed to have a substantially rectangular plate shape bent to the right side and having the forward-rearward direction as the plate thickness direction and is disposed on the side of the circular saw blade 16 in the cutting rotation direction with respect to the lower side ventilation exit part 64 in a side view. Accordingly, it is constituted such that chips discharged from the exit hole 64C of the lower side ventilation exit part 64 to the right side and the side of the circular saw blade 16 in the rotation direction collide with the stopper wall 84C. In other words, vigorous collision of chips from the exit hole 64C with a portion of the outer case 82 (front part of the button accommodation part 82D, which will be described below) is curbed by the stopper wall 84C.

In the upper end part of the inner case 84, a button insertion groove 84D for inserting the attachment/detachment button 86 (which will be described below) therethrough is formed on the rear side of the stopper wall 84C. The button insertion groove 84D is formed to have a recessed shape opening to the upper side and is disposed on the right side of the button insertion part 61C of the saw cover 60.

In addition, in the rear part of the inner case 84, the box-side exhaust outlets 84E serving as a plurality of (two locations in the present embodiment) exhaust parts are formed in a penetrating manner on the rear side of the box entrance section 84B (one side in the forward-rearward direction). Due to a plurality of box-side exhaust outlets 84E, invasion of chips or the like from the dust chamber 80A to the non-operation region 70C is curbed. The box-side exhaust outlets 84E are disposed adjacent to the right side of the communication hole 61B of the saw cover 60 and is disposed inside the communication hole 61B when viewed from the left side (refer to FIG. 8). Accordingly, the dust chamber 80A of the dust collection box 80 and the non-operation region 70C of the tool cover 70 communicate with each other through the communication hole 61B and the box-side exhaust outlets 84E. In other words, the non-operation region 70C and the box-side exhaust outlets 84E communicate with each other through the communication hole 61B. Thus, it is configured to be able to discharge an air flow which has flowed into the dust chamber 80A to the non-operation region 70C of the tool cover 70. In addition, the box-side exhaust outlets 84E are disposed at a position overlapping the box entrance section 84B in the upward-downward direction. The box-side exhaust outlets 84E are positioned behind the center of the circular saw blade 16. In addition, the communication hole 61B is formed as an opening having a size allowing a plurality of box-side exhaust outlets 84E to collectively communicate with the non-operation region 70C. For this reason, in a state in which the dust collection box 80 is detached, the inside of the non-operation region 70C is likely to be visually recognized through the communication hole 61B, and even when a foreign matter invades the non-operation region 70C, it is likely to be removed. In addition, as illustrated in FIGS. 8 and 12, the fixing screws SC for fixing the inner case 84 to the dust collection box 80 are positioned at the position of the communication hole 61B when viewed in the lateral direction. However, the communication hole 61B also functions as a clearance part for avoiding contact of head portions of the fixing screws SC (screw heads) with the circumferential cover part 62. In other words, the head portions of the fixing screws SC are configured to be positioned on the inward side of the communication hole 61B such that they do not come into contact with the circumferential cover part 62.

As also illustrated in (A) of FIG. 9, a box bottom part 84F bent to the right side is formed in the lower end part of the inner case 84, and the box bottom part 84F extends in the forward-rearward direction and is disposed adjacent to the upper side of the lower wall of the outer case 82. Accordingly, the box bottom part 84F constitutes the bottom part of the dust chamber 80A. In addition, an inclined part 84G corresponding to the case inclination part 82F of the outer case 82 is formed in the tip part of the box bottom part 84F. The inclined part 84G is inclined to the upper side toward the right side when viewed from the front side and is disposed adjacent to the left side of the case inclination part 82F of the outer case 82.

(Regarding Attachment/Detachment Button 86)

As illustrated in FIG. 1, FIG. 3, (A) of FIG. 9, and FIG. 11, the attachment/detachment button 86 is formed to have a substantially rectangular box shape opening to the lower side and is disposed inside the button accommodation part 82D of the outer case 82. Engagement projections 86A are respectively formed on front and rear surfaces of the attachment/detachment button 86. Further, the engagement projections 86A are disposed adjacent to the lower side of the interlock ribs 82E of the outer case 82.

In addition, a button spring 88 (refer to (A) of FIG. 9) is disposed inside the attachment/detachment button 86. The button spring 88 is configured to serve as a compression coil spring. The upper end part of the button spring 88 is interlocked with the upper wall of the attachment/detachment button 86, and the lower end part of the button spring 88 is interlocked with the lower wall of the button accommodation part 82D. Accordingly, the attachment/detachment button 86 is biased to the upper side by the button spring 88, and the engagement projections 86A abut the interlock ribs 82E. Therefore, the attachment/detachment button 86 is configured to be able to be subjected to a pressurization operation to the lower side.

In addition, a button engagement piece 86B is formed in the attachment/detachment button 86. The button engagement piece 86B protrudes from the attachment/detachment button 86 to the left side while having the upward-downward direction as the plate thickness direction. Specifically, the button engagement piece 86B is inserted through the inside of the button insertion groove 84D of the inner case 84, and the tip part of the button engagement piece 86B is inserted into the button insertion part 61C of the saw cover 60. The width measurement of the button engagement piece 86B (measurement in the forward-rearward direction) is set to be slightly smaller than the width measurement of the button insertion groove 84D. Accordingly, the position of the attachment/detachment button 86 in the forward-rearward direction is configured to be determined based on the button insertion groove 84D of the inner case 84. That is, movement of the attachment/detachment button 86 in the forward-rearward direction and the leftward direction is restricted by the inner case 84.

Moreover, an engaged hook part 86C protruding to the upper side is formed in the tip part of the button engagement piece 86B. The engaged hook part 86C is engaged with the upper side edge part of the button insertion part 61C of the saw cover 60 in the lateral direction. Accordingly, movement of the upper end part of the dust collection box 80 to the right side is limited. Further, the engagement state between the engaged hook part 86C and the saw cover 60 is canceled by pressurizing the attachment/detachment button 86 to the lower side. Accordingly, the dust collection box 80 is configured to be able to be detached from the tool main body 12. In this manner, the button insertion part 61C functions as a support part detachably supporting the dust collection box 80.

(Regarding Dust Collector Connection Part 90)

As illustrated in FIGS. 1, 3, 4, and 11, the dust collector connection part 90 is configured to include a mounted part 90A constituting the front part of the dust collector connection part 90, and a connection tube part 90B constituting the rear part of the dust collector connection part 90. The mounted part 90A is formed to have a substantially rectangular box shape opening to the front side. Further, the mounted part 90A is coupled to the mounting part 82G such that the mounting part 82G of the outer case 82 is blocked. Specifically, the upper end part of the mounted part 90A is rotatably coupled to the upper end part of the mounting part 82G of the outer case 82 while having the lateral direction as the axial direction.

The connection tube part 90B is formed to have a substantially cylindrical shape having the forward-rearward direction as the axial direction and protrudes from the mounted part 90A to the rear side. In addition, the inside of the connection tube part 90B and the inside of the mounted part 90A communicate with each other. Further, a hose of a dust collector (not illustrated) is configured to be connected to the rear end part of the connection tube part 90B. Accordingly, the dust collector is configured to suction chips in the dust collection box 80 and discharge the chips to the outside of the dust collection box 80. When the hose of the dust collector is not connected to the connection tube part 90B, a cap 92 having a bottomed cylindrical shape is attached to the connection tube part 90B.

### Operational Effects

Next, operations and effects of the cutting tool 10 of the present embodiment will be described.

During cutting of the cutting tool 10 constituted as described above, the base 14 is placed on a machining material, and the trigger 30 is subjected to a pulling operation. Accordingly, the motor 41 is driven, a driving force of the motor 41 is transmitted to the circular saw blade 16, and the circular saw blade 16 rotates in the cutting rotation direction. Further, when the cutting tool 10 is moved to the front side, the protective cover 54 rotates from the protection position to the operation position due to the machining material, and the lower part of the circular saw blade 16 is exposed. Accordingly, cutting is performed with respect to the machining material.

In addition, during operation of the cutting tool 10, the fan 46 rotates, and the air flow AR1 flowing into the main body housing 22 from the intake ports 22B is generated. The air flow AR1 flows to the outward side of the fan 46 in the radial direction and flows into the duct 26 from the opening part 22C of the main body housing 22 (refer to FIG. 5). The air flow AR1 which has flowed into the duct 26 branches into the air flow AR2 flowing to the first duct exhaust part 26C of the duct 26 and the air flow AR3 flowing to the second duct exhaust part 26D (refer to (A) of FIG. 10).

Further, as illustrated in (A) of FIG. 10 and (B) of FIG. 10, the air flow AR2 is sent from the first duct exhaust part 26C to the upper side ventilation exit part 65 and flows out to the right side (dust collection box 80 side) from the upper side ventilation exit part 65. Accordingly, the air flow AR2 flows into the dust chamber 80A from the box entrance section 84B of the dust collection box 80. The air flow AR2 which has flowed into the dust chamber 80A hits the case guide section 82B of the dust collection box 80 (inner wall of the dust chamber 80A) so that the direction of the air flow AR2 is changed to the lower side. Accordingly, the air flow AR2 flows in the front end part of the dust chamber 80A toward the lower side (refer to FIG. 12).

Meanwhile, as illustrated in FIG. 8 and (A) of FIG. 10, the air flow AR3 flows out to the upper side from the second duct exhaust part 26D and flows in the front end part of the operation region 70B of the tool cover 70 toward the upper side. In addition, during operation of the cutting tool 10, the air flow AR4 directed in the cutting rotation direction is generated due to rotation of the circular saw blade 16 and movement of cut-up machining chips. For this reason, the air flow AR3 is joined to the air flow AR4 and flows inside the front end part of the operation region 70B toward the upper side. Moreover, at this time, the air flow AR3 and the air flow AR4 are straightened by the lower side straightening piece 22D and the upper side straightening piece 64A and flows to the lower side ventilation exit part 64 side of the saw cover 60.

In addition, during cutting performed with respect to a machining material, chips generated by cutting are carried to the upper side due to vigor of cutting and the air flow AR4 of the circular saw blade 16. Specifically, chips are generated such that they are blown up from the front end outer circumferential part of the circular saw blade 16 toward the upper side and move upward and rearward along the outer circumferential part of the tool cover 70. For this reason, the air flow AR3 which has joined to the air flow AR4 flows into the lower side ventilation exit part 64 of the saw cover 60 together with chips which have moved upward. Further, the air flow AR3 and chips (air flow AR4) which have moved into the lower side ventilation exit part 64 are straightened to the exit hole 64C side of the lower side ventilation exit part 64 by the ventilation guide part 63A and flow out to the right side from the exit hole 64C. The air flow AR4 is included in the air flow AR3 which has arrived at the lower side ventilation exit part 64. However, for the sake of convenience of description, description for the air flow AR4 will hereinafter be omitted.

Further, as illustrated in (A) of FIG. 10 and (B) of FIG. 10, the air flow AR3 and chips flow into the dust chamber 80A from the box entrance section 84B of the dust collection box 80. Accordingly, chips fall down to the bottom part of the dust chamber 80A and are stored inside the dust chamber 80A. In addition, the air flow AR3 which has flowed into the dust chamber 80A hits the case guide section 82B of the dust collection box 80 so that the direction of the air flow AR3 is changed to the lower side. Accordingly, the air flow AR3 flows together with the air flow AR2 in the front end part of the dust chamber 80A toward the lower side (refer to FIG. 12).

As illustrated in FIG. 12, when the air flow AR2 and the air flow AR3 (that is, the air flow AR1) flowing to the lower side arrive at the lower end part of the dust chamber 80A, the air flow AR2 and the air flow AR3 hit the bottom part of the dust chamber 80A so that the directions of the air flow AR2 and the air flow AR3 are changed to the rear side. Accordingly, the air flow AR2 and the air flow AR3 flow from the front end part of the dust chamber 80A to the rear end part.

The box-side exhaust outlets 84E are formed in the rear end part of the dust collection box 80. In addition, since the air flow AR2 and the air flow AR3 are continuously sent to the inside of the dust chamber 80A as long as the fan 46 is rotating, the pressures at the front part and the lower part inside the dust chamber 80A rise. For this reason, the air flow AR2 and the air flow AR3 which have arrived at the rear end part of the dust collection box 80 are pushed by an air flow sent from the front, move upward, and flow toward the box-side exhaust outlets 84E. That is, the air flow AR2 and the air flow AR3 flow in the rear end part of the dust chamber 80A toward the upper side. Further, the air flow AR2 and the air flow AR3 are discharged into the non-operation region 70C of the tool cover 70 from the box-side exhaust outlets 84E. In this manner, a flow of air is formed inside the dust chamber 80A. Air discharged toward the leftward direction inside the non-operation region 70C moves to the inside of the tool cover 70 through a gap in the lateral direction provided between the left end part 63B (tip part) of the blocking part 63 and the right side of the cover base part 22A. Here, for instance, even if chips which have invaded the inside of the non-operation region 70C chips move to the inside of the tool cover 70 through the gap in the lateral direction, the gap is apart from the circular saw blade 16 in the leftward direction (FIG. 9). Therefore, contact between the circular saw blade 16 and chips is favorably curbed. In addition, since the cover base part 22A is a metal, even if chips come into contact therewith, there is almost no risk of deformation and breakage to the extent that it hinders workability. In addition, air discharged toward the leftward direction inside the non-operation region 70C moves to the inside of the tool cover 70 through the gap in the forward-rearward direction provided between the rear end of the blocking part 63 and the rear end inner wall of the cover base part 22A (and the rear end inner wall of the saw cover 60). Even if chips move to the inside of the tool cover 70 through the gap in the forward-rearward direction, since the gap in the forward-rearward direction (rear part 63D) is positioned behind the rear end of the circular saw blade 16 (FIG. 7, 8), contact of chips with the circular saw blade 16 can be curbed.

Incidentally, when a machining material is a metal material such as a mild steel, chips at a relatively high temperature are discharged into the dust chamber 80A of the dust collection box 80 from the lower side ventilation exit part 64 of the saw cover 60. In addition, the outer case 82 constituting the dust chamber 80A is made of a resin. For this reason, there is a likelihood that the outer case 82 will be thermally deformed due to the chips.

Here, as described above, the dust collection box 80 is configured to include the box entrance section 84B for causing the air flow AR1 generated by the fan 46 (air flow AR2 and air flow AR3) to flow into the dust chamber 80A, and the box-side exhaust outlets 84E for causing the air flow AR1 inside the dust chamber 80A to be discharged to the outside of the dust chamber 80A. The box-side exhaust outlets 84E are disposed on the rear side of the box entrance section 84B. In other words, the box entrance section 84B is provided in the front side portion of the dust collection box 80, and the box-side exhaust outlets 84E are provided in the rear side portion of the dust collection box 80. More specifically, the box entrance section 84B is provided in a portion in front of the center position of the dust collection box 80 in the forward-rearward direction, and the box-side exhaust outlets 84E are provided in portions behind the center position of the dust collection box 80 in the forward-rearward direction. Accordingly, a flow of the air flow AR1 moving from the front side to the rear side can be smoothened, and the dust collection box 80 can be favorably cooled. When both the box entrance section 84B and the box-side exhaust outlets 84E are provided in the front part or the rear part of the dust collection box 80, since the air flow AR1 is in a form of making a U-turn in the forward-rearward direction, there is a likelihood that the outward air flow AR1 will inhibit a flow of the inward air flow AR1 and a flow of air will be disturbed. However, in the present embodiment, such a situation can be curbed. In addition, the dust collection box 80 has the case guide section 82B for guiding the air flow AR1 which has flowed into the dust chamber 80A from the box entrance section 84B to the lower side. For this reason, as described above, the air flow AR1 which has flowed into the dust chamber 80A toward the right side flows in the front end part of the dust chamber 80A toward the lower side. Next, it flows in the lower end part of the dust chamber 80A to the rear side. Next, it flows in the rear end part of the dust chamber 80A to the upper side. Last, it flows to the left side and arrives at the box-side exhaust outlets 84E. That is, the air flow AR1 can flow almost entirely throughout the dust chamber 80A. Specifically, it is constituted such that a flow of air inside the dust chamber 80A is straightened in the order of the rightward direction, the downward direction, the rearward direction, the upward direction, and the leftward direction by causing a flow of air which has flowed in from the intake part (box entrance section 84B) to be aligned in the lateral direction while the intake part (box entrance section 84B) and the exhaust part (box-side exhaust outlets 84E) of the dust chamber 80A opening in the same one direction (leftward direction) are caused to be apart in the front and the rear. Accordingly, the inside of the dust chamber 80A can be efficiently cooled, and heat resistance of the cutting tool 10 can be improved. In addition, since chips also flow in the rightward direction from the box entrance section 84B, there is a high likelihood that chips in a state having heat will first contact with the right side inner wall of the dust chamber 80A (right side wall of the dust collection box 80), and it is important for a portion of the dust collection box 80 to secure heat resistance of the right side wall. However, in the present embodiment, it is constituted such that the air flow AR1 which has flowed into the dust chamber 80A toward the right side first hits the right side inner wall of the dust chamber 80A (right side wall of the outer case 82), the right side inner wall can be preferentially cooled. Accordingly, the resin outer case 82 constituting the dust chamber 80A can be efficiently cooled by the air flow AR1 which has flowed into the dust chamber 80A. Therefore, heat resistance of the cutting tool 10 can be improved. In addition, collected chips are accumulated in the lower part of the dust chamber 80A. However, since the air flow AR1 moves to the rear in the lower part of the dust chamber 80A, accumulated chips can be cooled at any time. Moreover, since the metal box bottom part 84F is positioned in the lower end of the dust chamber 80A, heat of accumulated chips can be absorbed from below and can be emitted. That is, since chips accumulated in the dust chamber 80A are quickly cooled by being cooled from both the lower side and the upper side, excessive transmission of heat of the chips to the outer case 82 can be curbed. Such a constitution can be easily constituted by the embodiment of this application in which the dust collection box 80 is connected to the right side of the saw cover 60. For example, in a case of a form in which the dust collection box 80 is attached to the upper part (outer circumferential portion) of the saw cover 60, it is highly necessary to attach the dust collection box 80 to the rear portion of the saw cover 60 or to dispose the intake part and the exhaust part of the dust collection box adjacent to each other. However, in the case of the embodiment of this application, since there is no such design limitation, the foregoing constitution can be easily employed. In addition, compared to a form in which the dust collection box 80 is attached to the upper part (outer circumferential portion) of the saw cover 60, in the case of the embodiment of this application in which the dust collection box 80 is connected to the right side of the saw cover 60, even if a rise position of chips cut up during machining is low, dust can be easily collected in the dust collection box 80. Therefore, even if the size of every single chip is larger than that of a wooden material, and even in a case of chips of a metal material (mild steel) having a large mass, dust collection can be favorably performed.

In addition, the box entrance section 84B and the box-side exhaust outlets 84E are disposed at positions overlapping each other in the upward-downward direction. Specifically, the box entrance section 84B and the box-side exhaust outlets 84E are formed in the upper end side portion of the dust collection box 80 and are disposed apart from each other in the forward-rearward direction. Accordingly, a large region can be set for the air flow AR1 flowing in the front end part and the rear end part of the dust chamber 80A in the upward-downward direction, and a chip collection space of the dust chamber 80A can also be secured. Therefore, the outer case 82 can be more efficiently cooled by the air flow AR1. The upper part of the circular saw blade 16 having a circular plate shape is covered by the saw cover 60. However, due to the structure covering the upper half of the circular member, the longitudinal direction thereof becomes the forward-rearward direction. Since the dust collection box 80 is attached to the saw cover 60 and has a shape similar to the external shape thereof, the longitudinal direction of the dust collection box 80 also becomes the forward-rearward direction. Here, since the box entrance section 84B and the box-side exhaust outlets 84E are disposed apart from each other in the forward-rearward direction, a large amount of air can be caused to flow forward and rearward inside the dust collection box 80, and the dust collection box 80 (dust chamber 80A) can be effectively cooled. Specifically, the box entrance section 84B is positioned in front of the center of the circular saw blade 16, and the box-side exhaust outlets 84E is configured to be positioned behind the center of the circular saw blade 16. In addition, the box entrance section 84B is positioned behind the front end of the circular saw blade 16, and the box-side exhaust outlets 84E is configured to be positioned in front of the rear end of the circular saw blade 16. The lower end position of the box-side exhaust outlets 84E is set to be higher than the lower end position of the box entrance section 84B, and when the inside of the dust chamber 80A is full of chips during cutting, chips first overflow from the box entrance section 84B. By means of this, entry of chips in the non-operation region 70C is curbed.

In addition, during operation of the cutting tool 10, the air flow AR2 including no chips flows out to the inside of the dust chamber 80A from the upper side ventilation exit part 65, and the air flow AR3 including chips flows out to the inside of the dust chamber 80A from the lower side ventilation exit part 64. Accordingly, while chips are discharged to the dust collection box 80, the air flow AR2 in which a temperature rise due to chips is curbed can be caused to flow into the dust collection box 80. Accordingly, the outer case 82 can be effectively cooled by the air flow AR2 including no chips.

In addition, as described above, the air flow AR2 flowing into the dust chamber 80A from the upper side ventilation exit part 65 is changed to a flow toward the lower side by the case guide section 82B. For this reason, utilizing the air flow AR2, chips discharged from the lower side ventilation exit part 64 together with the air flow AR3 can be biased to the lower side inside the dust chamber 80A. This effect is favorably realized due to the upper side ventilation exit part 65 and the lower side ventilation exit part 64 being adjacent to each other. In addition, it is also favorably realized due to the upper side ventilation exit part 65 and the lower side ventilation exit part 64 opening in the same direction. Accordingly, exposure of chips in the inside of the dust chamber 80A (due to rebound or the like) can be curbed, and a reverse flow of chips inside the dust chamber 80A moving upward due to rebound or the like from the lower side ventilation exit part 64 can be curbed. Therefore, a dust collection performance with respect to chips can be improved. Since the upper side ventilation exit part 65 has a lattice-shaped structure, even if chips move to the upper end inside the dust chamber 80A, a reverse flow from the upper side ventilation exit part 65 can be favorably curbed due to the lattice-shaped structure.

In addition, the duct 26 has the second duct exhaust part 26D, and the air flow AR3 is discharged toward the upper side from the second duct exhaust part 26D inside the tool accommodation region 70A of the tool cover 70 (operation region 70B). In addition, the second duct exhaust part 26D is disposed on the side below the lower side ventilation exit part 64. Accordingly, the air flow AR3 is discharged to the lower side ventilation exit part 64 side inside the tool accommodation region 70A (operation region 70B). For this reason, utilizing the air flow AR3, chips generated during cutting can be guided to the inside of the lower side ventilation exit part 64. Therefore, a dust collection performance with respect to chips can be further improved.

In addition, the second duct exhaust part 26D is disposed on the inward side of the external shape of the circular saw blade 16 in the radial direction in a side view. For this reason, interference of chips generated during cutting with the second duct exhaust part 26D can be curbed. That is, damage or deformation of the second duct exhaust part 26D due to chips can be curbed, and the air flow AR3 can be discharged from the second duct exhaust part 26D while inhibition of a flow of chips by the second duct exhaust part 26D is curbed. Moreover, the upward air flow AR3 becomes a curtain for a flow of air so that movement of chips to the rear beyond the second duct exhaust part 26D can be curbed, and efficiency of dust collection can be further improved. In addition, the second duct exhaust part 26D does not open immediately upward but opens toward the front in a slightly inclined manner. Accordingly, air discharged from the second duct exhaust part 26D is directed toward the front and is directed toward the lower side ventilation exit part 64 thereafter. Chips moving upward are biased to the front by making such a flow of air. Therefore, excessive movement of chips to the rear can be curbed, and chips can be more favorably guided to the lower side ventilation exit part 64. In addition, since air discharged from the second duct exhaust part 26D is directed toward the front, disturbance of a flow of the air flow AR3 by the upper side straightening piece 64A is curbed. That is, when air is discharged immediately upward from the second duct exhaust part 26D, there is concern that the air flow may collide with the upper side straightening piece 64A and the flow of air may be disturbed. However, in the present embodiment, a constitution in which such disturbance of air is unlikely to occur can be obtained, and improvement in performance of dust collection and cooling can be achieved.

In addition, the lower side straightening piece 22D and the upper side straightening piece 64A are provided between the lower side ventilation exit part 64 and the second duct exhaust part 26D, and the air flow AR3 discharged from the second duct exhaust part 26D is straightened to the second duct exhaust part 26D side by the lower side ventilation exit part 64 and the second duct exhaust part 26D. Accordingly, the air flow AR3 flowing inside the tool cover 70 (operation region 70B) can be caused to efficiently flow into the lower side ventilation exit part 64. In addition, the upper side straightening piece 64A also functions as a wall member curbing movement of chips generated by working to the rear beyond the position of the upper side straightening piece 64A, and dust collection efficiency of chips can be improved.

In addition, the ventilation guide part 63A is formed in the lower side ventilation exit part 64 of the saw cover 60, and the ventilation guide part 63A is inclined to the right side (dust collection box 80 side) toward the cutting rotation direction of the circular saw blade 16. For this reason, the air flow AR3 which has flowed into the lower side ventilation exit part 64 is straightened, and the direction of the air flow AR3 can be changed to the dust collection box 80 side. Accordingly, the air flow AR3 can be caused to efficiently flow into the dust chamber 80A of the dust collection box 80.

In addition, the case guide section 82B of the dust collection box 80 is disposed in a manner of facing the lower side ventilation exit part 64 and the upper side ventilation exit part 65 in the lateral direction and constitutes a portion of the inner circumferential surface of the dust chamber 80A. Accordingly, utilizing the inner circumferential surface of the dust chamber 80A, the directions of the air flow AR2 and the air flow AR3 flowing into the dust chamber 80A can be changed to the lower side. In addition, since the outer case 82 is made of a resin, the case guide section 82B can be easily molded into a suitable shape. Moreover, since the outer case 82 is formed of a transparent resin material, the state of chips accumulated in the dust chamber 80A can be easily seen. Since a resin material often has lower heat resistance than a metal material, there is concern that the heat resistance may deteriorate when the inside of the dust chamber 80A can be seen due to a resin material as described above. However, in the present embodiment, since the heat resistance of the outer case 82 is improved, workability can be improved.

In addition, in the dust chamber 80A of the dust collection box 80, the measurement in the upward-downward direction is set to be smaller than the measurement in the forward-rearward direction. For this reason, in the dust collection box 80 disposed adjacent to the right side of the tool cover 70 covering the upper part of the circular saw blade 16, a large cross-sectional area of the dust chamber 80A storing chips viewed from the right side can be set.

In addition, in the cutting tool 10, the blocking part 63 is formed in the saw cover 60 constituting the tool cover 70, and the tool accommodation region 70A inside the tool cover 70 is divided into the operation region 70B and the non-operation region 70C by the blocking part 63. Moreover, the box-side exhaust outlets 84E are formed in the inner case 84 of the dust collection box 80, and the dust chamber 80A and the non-operation region 70C communicate with each other through the box-side exhaust outlets 84E. Accordingly, the tool cover 70 can be cooled by discharging the air flow AR2 and the air flow AR3 which have flowed into the dust chamber 80A into the non-operation region 70C from the box-side exhaust outlets 84E. Therefore, the heat resistance of the cutting tool 10 can be improved.

Moreover, the upper part of the circular saw blade 16 is accommodated in the operation region 70B and is covered by the tool cover 70. Accordingly, a rotation operation of the circular saw blade 16 can be favorably maintained. That is, for example, even when the blocking part 63 is omitted in the saw cover 60, the air flow AR2 and the air flow AR3 for cooling the dust collection box 80 can be discharged into the tool accommodation region 70A of the tool cover 70. However, in this case, there is concern that chips inserted into the dust chamber 80A may be discharged into the tool accommodation region 70A (around the circular saw blade 16) from the box-side exhaust outlets 84E. For instance, if chips are discharged, there is concern that the inner circumferential side of the tool cover 70 may be deformed or break due to heat of the chips or chips which have hit the circular saw blade 16 during rotation and rebounded. In addition, in this case, there is a likelihood that a defect will occur in a rotation operation of the circular saw blade 16 due to deformation in the tool cover 70 or a breakage part. Accordingly, there is concern that reliability of the cutting tool 10 may deteriorate.

In contrast, in the present embodiment, the tool accommodation region 70A inside the tool cover 70 is divided into the operation region 70B and the non-operation region 70C by the blocking part 63, and the upper part of the circular saw blade 16 is accommodated in the operation region 70B. For this reason, for instance, even if chips inserted into the dust chamber 80A are discharged to the non-operation region 70C from the box-side exhaust outlets 84E, a situation in which the chips hit the circular saw blade 16 or the inner wall of the operation region 70B can be curbed by the blocking part 63. Accordingly, compared to the foregoing case, breakage of the inner circumferential surface of the tool cover 70 can be curbed. Therefore, a rotation operation of the circular saw blade 16 can be favorably maintained, and reliability of the cutting tool 10 can be improved. In addition, the box-side exhaust outlets 84E are positioned above the rear part 63D of the blocking part 63. However, since the rear part 63D is inclined downward, even if chips move to the upper surface of the blocking part 63 from the box-side exhaust outlets 84E, the chips are guided to the rear due to the shape of the inclined surface and operation of the empty weight. Moreover, since the rear end of the rear part 63D is positioned behind the rear end of the circular saw blade 16, chips can be discharged from the non-operation region 70C such that contact with the circular saw blade 16 is avoided due to guidance of the rear part 63D. In addition, since the restriction part 22E is positioned in front of the box-side exhaust outlets 84E, movement of chips which have invaded the non-operation region 70C to the region in front of the box-side exhaust outlets 84E is curbed. Although the button insertion part 61C supporting the dust collection box 80 is positioned in front of the box-side exhaust outlets 84E, deformation or breakage of the button insertion part 61C and an area therearound due to chips can be curbed by the restriction part 22E.

In addition, the lower part of the circular saw blade 16 is covered by the protective cover 54. During cutting of the cutting tool 10, the protective cover 54 rotates to the operation position from the protection position and is disposed inside the operation region 70B of the tool cover 70. Accordingly, for instance, even if chips inserted into the dust chamber 80A are discharged to the non-operation region 70C from the box-side exhaust outlets 84E, a situation in which the chips directly hit the protective cover 54 can be curbed by the blocking part 63. Accordingly, thermal deformation of the protective cover 54 due to chips can be curbed. Therefore, an operational defect of the protective cover 54 rotating between the protection position and the operation position can be reduced.

In addition, the blocking part 63 is formed with the saw cover 60 as a single piece. Accordingly, the blocking part 63 dividing the tool accommodation region 70A of the tool cover 70 can be easily formed.

In the present embodiment, the blocking part 63 is formed in the saw cover 60. However, a blocking part may be formed in the inner case 84 of the dust collection box 80, and the tool accommodation region 70A of the tool cover 70 may be configured to be divided into the operation region 70B and the non-operation region 70C.

### REFERENCE SIGNS LIST

10 Cutting tool (work machine)
16 Circular saw blade (tip tool)
22D Lower side straightening piece (first straightening part)
26 Duct
26C First duct exhaust part
26D Second duct exhaust part
41 Motor
46 Fan
63A Ventilation guide part (second straightening part)
64 Lower side ventilation exit part (second ventilation exit part)
64A Upper side straightening piece (first straightening part)
65 Upper side ventilation exit part (first ventilation exit part)
70 Tool cover
80 Dust collection box
80A Dust chamber
82 Outer case (case)
82B Case guide section (guide part)
84B Box entrance section (intake part)
84E Box-side exhaust outlet (exhaust part)

1. A work machine comprising:
a motor that drives a tip tool for performing cutting forward with respect to a machining material;
a fan that rotates due to driving of the motor;
a tool cover that covers at least a portion of the tip tool; and
a dust collection box that is connected to the tool cover,
wherein the dust collection box includes
an intake part for causing an air flow generated due to rotating of the fan or an air flow generated due to cutting to flow into the dust collection box and being provided in a front part of the dust collection box, and
an exhaust part for causing the air flow which has flowed into the dust collection box to be discharged to the outside of the dust collection box and being provided in a rear part of the dust collection box, and
wherein the intake part and the exhaust part are apart from each other in a forward-rearward direction, and an air passage connecting the intake part and the exhaust part is formed in the dust collection box in a manner of extending in the forward-rearward direction.

2. (canceled)

3. The work machine according to claim 1,
wherein the tool cover has a ventilation part connected to the intake part, and the air flow generated by the fan or the air flow generated by cutting is sent to the intake part by the ventilation part.

4. A work machine comprising:
a motor that drives a tip tool for performing cutting forward with respect to a machining material;
a fan that rotates due to driving of the motor;
a tool cover that covers at least a portion of the tip tool; and
a dust collection box that is connected to the tool cover,
wherein the tool cover is provided with a ventilation part for sending an air flow generated by rotating of the fan and an air flow generated by cutting to the dust collection box,
wherein the dust collection box has
a case internally having a dust chamber for collecting machining chips generated during cutting,
an intake part connected to the ventilation part and causing the air flow to flow into the dust chamber, and
an exhaust part causing the air flow which has flowed into the dust chamber to be discharged to an inward side of the tool cover, and
wherein the work machine further comprises an air passage that is configured to cause the air flow generated by the fan to flow into the dust collection box via the intake part and to be discharged to the inward side of the tool cover from the exhaust part.

5. The work machine according to claim 4,
wherein the ventilation part has
a first ventilation exit part for causing the air flow generated by the fan to flow out to the intake part without passing through an operation space of the tip tool in the tool cover, and
a second ventilation exit part for causing the air flow generated by cutting to flow out to the intake part.

6. The work machine according to claim 5,
wherein the first ventilation exit part and the second ventilation exit part are disposed adjacent to each other.

7. The work machine according to claim 5,
wherein the first ventilation exit part and the second ventilation exit part are open in the same direction.

8. The work machine according to claim 5,
wherein the dust collection box has a guide part for guiding the air flow flowing into the dust chamber from the intake part to a lower side,
wherein the first ventilation exit part is disposed on a side above the second ventilation exit part, and
wherein the air flow which has flowed out to the intake part from the first ventilation exit part is guided to the lower side by the guide part.

9. The work machine according to claim 5,
wherein the second ventilation exit part communicates with the inside of the tool cover,
wherein the ventilation part is configured to include a duct for causing the air flow to branch, and
wherein the duct has a first duct exhaust part for causing one of the branched air flows to be discharged to the first ventilation exit part and a second duct exhaust part for causing the other of the branched air flows to be discharged to the inside of the tool cover, and the other of the branched air flows is discharged to the second ventilation exit part side by the second duct exhaust part.

10. The work machine according to claim 9,
wherein the tip tool is a circular saw blade having a circular shape, and
wherein the second duct exhaust part is disposed on the inward side of an external shape of the circular saw blade in a radial direction when viewed in a plate thickness direction of the circular saw blade.

11. The work machine according to claim 9,
wherein a first straightening part is provided between the second ventilation exit part and the second duct exhaust part, and
wherein the first straightening part straightens the air flow discharged from the second duct exhaust part to the second ventilation exit part side.

12. The work machine according to claim 4,
wherein the tip tool is a circular saw blade having a circular shape, and the tool cover is configured to cover an upper part of the circular saw blade, and
wherein a measurement of the dust chamber in an upward-downward direction is set to be smaller than a measurement thereof in a forward-rearward direction.

13. The work machine according to claim 4,
wherein the tip tool is a circular saw blade having a circular shape,
wherein the intake part is positioned in front of a rotation center of the circular saw blade, and
wherein the exhaust part is positioned behind the rotation center of the circular saw blade.

14. The work machine according to claim 13,
wherein the intake part is positioned behind a front end of the circular saw blade, and
wherein the exhaust part is positioned in front of a rear end of the circular saw blade.

15. The work machine according to claim 4,
wherein a base for sliding on the machining material is provided below the tool cover, and
wherein the dust collection box is attached to one side of the tool cover in a lateral direction.

16. The work machine according to claim 1,
wherein the tip tool is a circular saw blade having a circular shape, and the tool cover is configured to cover an upper part of the circular saw blade, and
wherein a measurement of the dust collection box in an upward-downward direction is set to be smaller than a measurement thereof in a forward-rearward direction.

17. The work machine according to claim 1,
wherein the tip tool is a circular saw blade having a circular shape,
wherein the intake part is positioned in front of a rotation center of the circular saw blade, and
wherein the exhaust part is positioned behind the rotation center of the circular saw blade.

18. The work machine according to claim 1,
wherein a base for sliding on the machining material is provided below the tool cover, and
wherein the dust collection box is attached to one side of the tool cover in a lateral direction.

19. The work machine according to claim 3,
wherein the ventilation part has
a first ventilation exit part for causing the air flow generated by the fan to flow out to the intake part without passing through an operation space of the tip tool in the tool cover, and
a second ventilation exit part for causing the air flow including the machining chips to flow out to the intake part,
wherein at least a part of the first ventilation exit part is disposed on a side above the second ventilation exit part or is disposed on a side in front of the second ventilation exit part.

20. The work machine according to claim 5,
wherein at least a part of the first ventilation exit part is disposed on a side above the second ventilation exit part or is disposed on a side in front of the second ventilation exit part.
